(19) United States
(12) Patent Application Publication
(10) Pub. No.: US 2021/0087022 A1
(43) Pub. Date: Mar. 25, 2021

(54) DEVICE FOR DETECTING ABNORMALITY IN PASSENGER CONVEYOR

(71) Applicant: Mitsubishi Electric Corporation, Tokyo (JP)

(72) Inventors: Ryu OKUDA, Tokyo (JP); Shingo DOI, Tokyo (JP)

(73) Assignee: Mitsubishi Electric Corporation, Tokyo (JP)

(21) Appl. No.: 17/044,518

(22) PCT Filed: Jun. 7, 2019
(86) PCT No.: PCT/JP2019/022703

§ 371 Date: Oct. 1, 2020

(30) Foreign Application Priority Data
Jun. 14, 2018 (JP) 2018-113594

(51) Int. Cl. B66B 29/04; B66B 31/00

(52) U.S. Cl. CPC B66B 29/04; B66B 31/00

(57) ABSTRACT

Provided is an abnormality detection device, in which a sound signal acquisition unit connected to a passenger conveyor converts a sound wave around each of inspection guide shoes mounted to a step into a sound signal. A sound signal analysis unit analyses the sound signal and extracts a sound pressure or a main frequency. The controller has not only a function as a command unit configured to command an operation for causing the step to run but also a function as an abnormality determination unit configured to determine an abnormality in skirt guards based on the sound pressure or the main frequency. The sound signal analysis unit in the abnormality detection device analyzes the sound signal acquired by the sound signal acquisition unit under a state in which the step is caused to run, and extracts the sound pressure or the main frequency.

### TECHNICAL FIELD

The present invention relates to a passenger conveyor abnormality detection device configured to detect an installation abnormality in skirt guards, which are provide upright, in a passenger conveyor.

### BACKGROUND ART

A skirt guard guiding system has hitherto been known as one of guiding mechanisms for steps of a passenger conveyor such as a moving walkway or an escalator. The skirt guard guiding system includes projecting portions extending from end surfaces of a step to a right side and a left side with respect to a traveling direction and having guide shoes at respective distal ends. The skirt guard guiding system has such a structure that the guide shoes slide along skirt guards, which are provided upright, to thereby guide the steps.

In a case in which right and left skirt guards are installed with a small dimension therebetween in the passenger conveyor described above, there is confirmed a phenomenon that a sliding noise is generated when the guide shoes pass through a portion with the small dimension between the skirt guards. In the following description, such an installation state of the skirt guards that may cause the sliding noise is regarded as an abnormality in the skirt guards.

A friction coefficient also has an influence on the generation of the sliding noise. When a sliding surface is in a low friction state, abnormal noise is not generated. However, when the friction coefficient is increased under an influence of a subsequent continuous operation of the passenger conveyor over time, the abnormal noise is generated at an abnormal portion of the skirt guards.

Due to the circumstances described above, when an abnormality in the skirt guards is inspected at time of installation or maintenance, a degree of abnormality cannot be sufficiently determined for the generation of abnormal noise by only checking presence or absence of the abnormal noise while performing a normal operation of the passenger conveyor. Thus, for checking the installation state, the following work is generally performed. The operation and stop of the passenger conveyor are repeated to gradually move positions of steps along the skirt guards, which are provided upright, over an entire length of a forward path of the steps from a lower reverse position to an upper reverse position of the passenger conveyor. Every time the positions of the steps are moved, a worker places, for example, a dedicated gauge between the guide shoe and the skirt guard to check the installation state.

However, there arises a problem in that extremely long working time is required for the above-mentioned work. Thus, there is a demand for a method which enables inspection of an abnormality in the skirt guards within a short period of time through continuous processing such as the operation of the passenger conveyor. Thus, there is given a skirt guard gap measurement device as a well-known technology of inspecting the installation state of the skirt guards while causing the passenger conveyor to run (see, for example, Patent Literature 1).

### CITATION LIST

### Patent Literature

[PTL 1] JP 63-190271 A

### SUMMARY OF INVENTION

### Technical Problem

With the technology described in Patent Literature 1, arms configured to extend and contract with respective ends being in sliding contact with the skirt guards are fixed on the step. An electric signal obtained by conversion of an extension and contraction amount of each of the arms is processed. In this manner, a gap width between an end surface of the step and the skirt guard is recorded.

With the technology described in Patent Literature 1, a gap width dimension between the end surface of the step and the skirt guard, which is stipulated in regulations in terms of catch prevention, is measured as a prerequisite. However, the technology described in Patent Literature 1 is not intended to determine the degree of abnormality for the generation of abnormal noise with the skirt guards.

Further, with the technology described in Patent Literature 1, the gap width dimension in the vicinity of the step is measured. Thus, a measurement point is not located in a portion over which the guide shoe passes. Thus, with the technology described in Patent Literature 1, even though a flat surface is equally given, an abnormality in the skirt guards which cannot keep an ideal flat surface in a vertical direction due to, for example, a strain that occurs in a manufacture process or misalignment that occurs at the time of installation cannot be accurately determined. Thus, with use of data obtained by the technology described in Patent Literature 1, an abnormality in the skirt guards cannot be accurately determined.

It is now supposed a case in which measurement devices such as the arms or a laser, which are disclosed in the technology described in Patent Literature 1, are moved from positions on a front side of the step to a back side of the step so that each of the measurement positions is located in the portion over which the guide shoe passes. Even on the supposition described above, application of the technology described above is limited to a case in which a dimension between the skirt guards is large to such a degree that a surface of the skirt guard and a surface of the guide shoe do not come into contact with each other.

In other cases, for example, when the dimension between the skirt guards is small to such a degree that both of the right and left guide shoes come into contact with the surfaces of the skirt guards, specifically, the guide shoes apply tension on the skirt guards, an original installation state of the skirt guards cannot be correctly estimated. The reason is that flexural deformation occurs in the skirt guards due to pressing forces of the guide shoes.

In order to avoid the situation described above, it may be conceivable to perform an operation of, for example, reducing a thickness of each of the guide shoes as compared to that of a related-art one or removing one of the guide shoes. Even in this case, however, an end surface of a step main body may interfere with the skirt guard to damage the measurement device in some cases. Further, in the work of removing the step main body and fixing the measurement devices to, for example, a step shaft, which is now free, and operating the passenger conveyor, the operation is performed under a state in which an opening portion is exposed. Thus, a safety problem may arise. For the reasons described above, it can be said that, with the technology described in Patent Literature 1, it is difficult to detect an abnormal portion of the skirt guards.

In short, even though an abnormal portion of the skirt guards needs to be easily detected within a short period of time, it is difficult to operate the passenger conveyor to continuously detect an abnormality in the skirt guards with a well-known technology. Further, it is also difficult to detect an abnormality in the skirt guards before the guide shoe slides along the skirt guard to generate the abnormal noise due to, for example, change with elapse of time.

The present invention has been made to solve the problems described above, and has an object to provide a passenger conveyor abnormality detection device capable of continuously detecting an abnormality in skirt guards while operating a passenger conveyor before abnormal noise is generated with normal guide shoes.

### Solution to Problem

In order to achieve the above-mentioned object, according to one embodiment of the present invention, there is provided a passenger conveyor abnormality detection device configured to detect an abnormality in skirt guards, which are provided upright, at time of inspection work for a passenger conveyor having a structure in which guide shoes mounted to each of steps slide along the skirt guards to guide the steps, the passenger conveyor abnormality detection device including: inspection guide shoes to be mounted to one of the steps; a sound signal acquisition unit configured to convert a sound wave around each of the inspection guide shoes into a sound signal; a command unit configured to command an operation for causing the steps to run; a sound signal analysis unit configured to analyze the sound signal acquired by the sound signal acquisition unit under a state in which the steps are caused to run by the command unit and extract a sound pressure or a main frequency; and an abnormality determination unit configured to specify an abnormal portion of the skirt guards based on the sound pressure or the main frequency, which has been extracted by the sound signal analysis unit.

### Advantageous Effects of Invention

According to one embodiment of the present invention, with the configuration described above, the passenger conveyor is operated so that an abnormality in the skirt guards can be continuously detected before the abnormal noise is generated with normal guide shoes.

### BRIEF DESCRIPTION OF DRAWINGS

FIG. 1 is a block diagram for illustrating an overall configuration of a passenger conveyor abnormality detection device according to a first embodiment of the present invention.

FIG. 2 is a side view for illustrating a schematic configuration of a passenger conveyor to which the passenger conveyor abnormality detection device illustrated in FIG. 1 is applied.

FIG. 3 is a perspective view for illustrating an exterior configuration of a step of the passenger conveyor illustrated in FIG. 2 when a front side is viewed from an obliquely upper side.

FIG. 4 is a side view for exemplifying a guide shoe to be mounted to the step illustrated in FIG. 3 when viewed along a plane orthogonal to a traveling direction of the step.

FIG. 5 is a side view for exemplifying the guide shoe to be mounted to the step illustrated in FIG. 3 when viewed along a plane parallel to a tread portion of the step.

FIG. 6 is a partially transparent side view for exemplifying a fitted state of the guide shoe to be mounted to the step illustrated in FIG. 3 into a connector when viewed along the plane orthogonal to the traveling direction of the step.

FIG. 7 is an external perspective view for illustrating a state in which the guide shoe to be mounted to the step illustrated in FIG. 3 is fitted into the connector when viewed from an obliquely upper side with respect to the traveling direction of the step.

FIG. 8 is a view for illustrating the fitted state of the guide shoes to be mounted to the step illustrated in FIG. 3 into the connectors and a positional relationship with respect to skirt guards when viewed from an upper surface side of the tread portion of the step.

FIG. 9 is a characteristic graph for showing a sound pressure with respect to a pressing force between members relating to a dimension between right and left skirt guards of the passenger conveyor illustrated in FIG. 2 and generation of abnormal noise.

FIG. 10 is a functional block diagram for illustrating a detailed configuration of a controller included in the passenger conveyor abnormality detection device illustrated in FIG. 1.

FIG. 11 is a flowchart for illustrating a procedure of abnormality detection processing in a sound-pressure determination mode, which is performed by the passenger conveyor abnormality detection device illustrated in FIG. 1.

FIG. 12 is a partially transparent side view for exemplifying a fitted and bonded state of an inspection guide shoe, which is to be mounted to the step to be used with the passenger conveyor abnormality detection device illustrated in FIG. 1, into the connector when viewed along the plane orthogonal to the traveling direction of the step.

FIG. 13 is a graph for showing a characteristic of the sound pressure with respect to a travel distance of the inspection guide shoe, which is associated with an abnormality detection result in the sound-pressure determination mode, which is obtained by the passenger conveyor abnormality detection device illustrated in FIG. 1.

FIG. 14 is a graph for showing a characteristic of a main frequency with respect to a pressing force between members, which is computed by a computing unit of a controller included in a passenger conveyor abnormality detection device according to a second embodiment.

FIG. 15 is a flowchart for illustrating a procedure of abnormality detection processing in a main-frequency determination mode, which is performed by the passenger conveyor abnormality detection device illustrated in FIG. 14.

FIG. 16 is a graph for showing a characteristic of a main frequency with respect to a travel distance of the inspection guide shoe, which is associated with an abnormality detection result in the main-frequency determination mode, which is obtained by the passenger conveyor abnormality detection device illustrated in FIG. 14.

### DESCRIPTION OF EMBODIMENTS

Now, passenger conveyor abnormality detection devices according to embodiments of the present invention are described in detail with reference to the drawings.

### First Embodiment

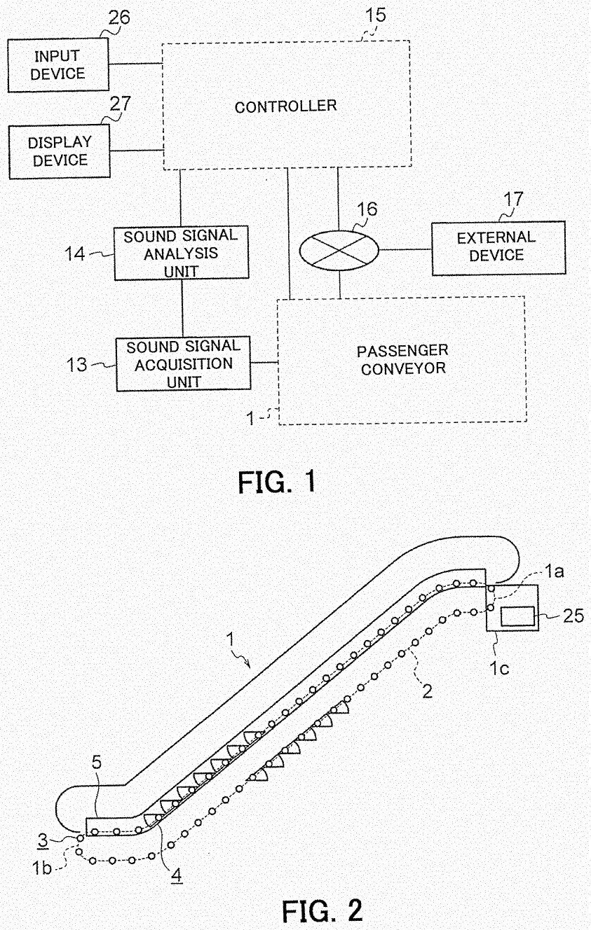

FIG. 1 is a block diagram for illustrating an overall configuration of a passenger conveyor abnormality detection device (hereinafter referred to as “abnormality detection device”) according to a first embodiment of the present invention. FIG. 2 is a side view for illustrating a schematic configuration of a passenger conveyor 1 to which the above-mentioned abnormality detection device is applied.

First, referring to FIG. 2, the passenger conveyor 1 has an escalator structure. Right and left step chains 2 are each formed in an endless shape by connection through step shafts 3 arranged at given intervals. Steps 4 are fixed to the step shafts 3, and power is transmitted from a power unit to the step chains 2. With the transmission of power, the steps 4 are driven in an ascending direction or a descending direction through the step shafts 3 that are connected. The step chain 2 and a plurality of skirt guards 5 are provided on each of sides of the steps 4. The skirt guards 5 are provided upright and arranged so as to be adjacent to each other to prevent a passenger from being caught by, for example, the power unit. A machine room 1c, in which a control panel 25 is installed, is provided under a floor on an upstairs side. An upper reverse position 1a for the step chains 2 and the steps 4 is defined inside the machine room 1c. Meanwhile, a lower reverse position 1b for the step chains 2 and the steps 4 is defined under a floor on a downstairs side. A moving walkway structure is configured in substantially the same manner except for that the step chains 2 and the steps 4 extend in a planar manner without being inclined.

In a passenger conveyor adopting a skirt guard guiding system, guide shoes are provided to a distal end in a traveling direction of the steps 4 so as to be located on the right and left sides, and slid against the skirt guards 5. In this manner, straight movement of the steps 4 can be ensured without interference of end surfaces of each of the steps 4 with the skirt guards 5. This structure is described later in detail.

Next, referring to FIG. 1, the abnormality detection device is configured to be used for the passenger conveyor 1 adopting the skirt guard guiding system. The abnormality detection device includes a sound signal acquisition unit 13, a sound signal analysis unit 14, a controller 15, a network 16, an external device 17, an input device 26, and a display device 27.

In the abnormality detection device, the sound signal acquisition unit 13 is connected to the passenger conveyor 1, and is configured to convert a sound wave around each of inspection guide shoes mounted to the step 4 into a sound signal. The sound signal analysis unit 14 is connected to the sound signal acquisition unit 13, and is configured to analyze the sound signal and extract a sound pressure or a main frequency. The input device 26 is connected to the controller 15. A worker operates and instructs the input device 26 to input an operation command to the controller 15. The display device 27 is connected to the controller 15, and is configured to display, for example, a content of the operation instruction associated with the operation command input by the worker to the input device 26 or an abnormality detection result.

The controller 15 is connected to the above-mentioned units, the passenger conveyor 1, and the network 16, and is configured to operate the passenger conveyor 1 while transmitting and receiving information to and from each of the units to thereby detect an abnormality in the skirt guards 5. Specifically, the controller 15 has functions as a command unit and an abnormality determination unit. The command unit is configured to command an operation for causing the steps 4 to run. The abnormality determination unit is configured to determine an abnormality in the skirt guards 5 based on the sound pressure or the main frequency, which is extracted by the sound signal analysis unit 14. Thus, the above-mentioned sound signal analysis unit 14 is configured to analyze the sound signal acquired by the sound signal acquisition unit 13 under a state in which the steps are caused to run by the command unit and extract the sound pressure or the main frequency.

Further, the controller 15 is connected to the external device 17 via the network 16. Thus, the controller 15 is configured so as to be communicable with the external device 17 via the network 16.

In the abnormality detection device illustrated in FIG. 1, when the sound signal acquisition unit 13 has the function of the sound signal analysis unit 14, specifically, the function of analyzing the sound signal and extracting the sound pressure or the main frequency, it is not required that the sound signal analysis unit 14 be configured as a separate unit. The controller 15 is connected to the control panel 25, which has been described above with reference to FIG. 2.

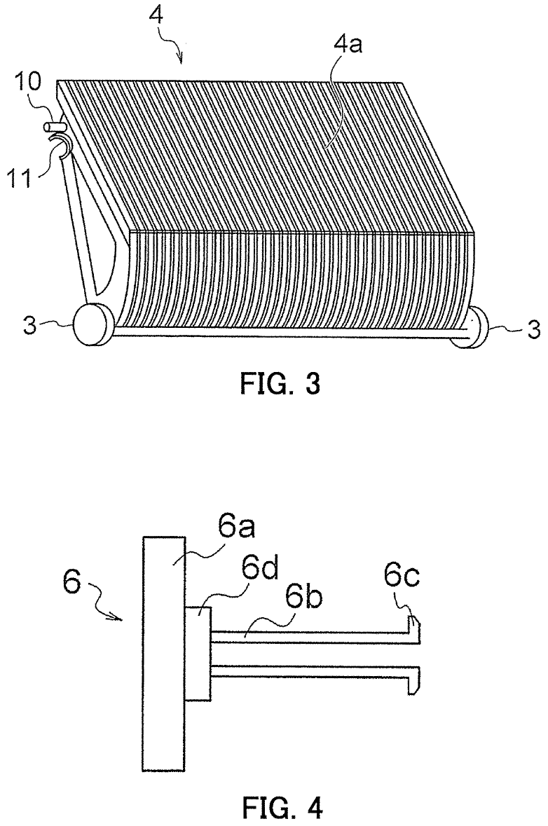

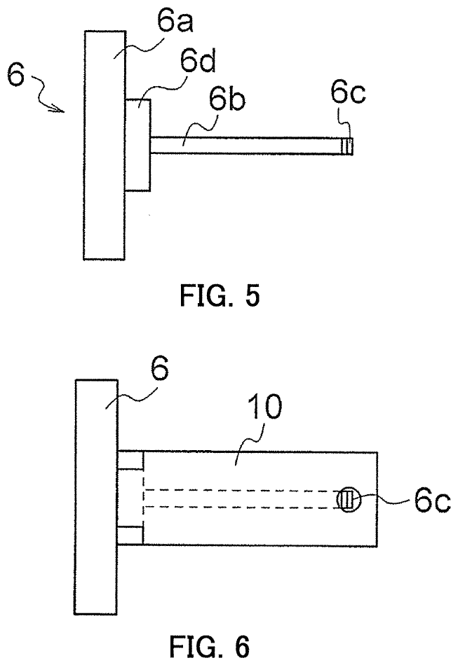

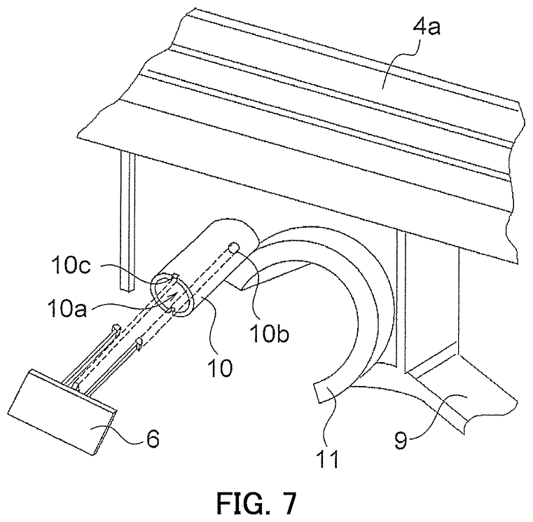

FIG. 3 is a perspective view for illustrating an exterior configuration of the step 4 of the passenger conveyor 1 when a front side is viewed from an obliquely upper side. FIG. 4 is a side view for exemplifying a guide shoe 6 to be mounted to the step 4 when viewed along a plane orthogonal to a traveling direction of the step 4. FIG. 5 is a side view for exemplifying the guide shoe 6 to be mounted to the step 4 when viewed along a plane parallel to a tread portion 4a of the step 4. FIG. 6 is a partially transparent side view for exemplifying a fitted state of the guide shoe 6 to be mounted to the step 4 into a connector (pipe sleeve) 10 when viewed along the plane orthogonal to the traveling direction of the step 4. FIG. 7 is an external perspective view for illustrating a state in which the guide shoe 6 to be mounted to the step 4 is fitted into the connector 10 when viewed from an obliquely upper side with respect to the traveling direction of the step 4.

Referring to FIG. 7, the step 4 includes brackets 9 provided on a back portion of the tread portion 4a, on which a passenger steps, so as to be located on the right side and the left side. The connector 10, into which the guide shoe 6 is to be mounted, is provided at a side portion of each of the brackets 9. Further, an engagement portion 11 having a substantially C-shape is provided at a back portion of the bracket 9. The engagement portion 11 grips the step shaft 3 connected to the step chain 2 to be coupled to the passenger conveyor 1.

Referring to FIG. 4 and FIG. 5, the guide shoe 6 has a protruding portion 6d on one side of a base portion 6a. A pair of leg portions 6b are provided to the protruding portion 6d so as to extend therefrom. Each of the leg portions 6b is provided so that a projecting portion of a claw portion 6c provided at a distal end is oriented outward. Further, referring to FIG. 7, an insertion hole 10a configured to allow insertion of the leg portions 6b and the claw portions 6c of the guide shoe 6 in a normal direction of the skirt guard 5 is formed in the connector 10. Further, two drilled holes 10b configured to allow the claw portions 6c of the guide shoe 6 to be hooked are formed at intermediate portions of the connector 10 in a horizontal direction. In addition, grooves 10c are formed in a distal end portion of the connector 10 so as to be arranged in a vertical direction.

The connectors 10 described above are provided at both end portions of the step 4 in the traveling direction of the step 4. When the guide shoe 6 is mounted, the leg portions 6b and the claw portions 6c are inserted into the insertion hole 10a, as illustrated in FIG. 7. At this time, as illustrated in FIG. 6, the claw portions 6c are inserted so as to be hooked to the right and left drilled holes 10b of the connector 10 to thereby fulfill a retaining function. In this manner, when the protruding portion 6d of the guide shoe 6 is fitted into the groove 10c of the connector 10, a posture of the guide shoe 6 is fixed, and rotation of the guide shoe 6 itself is prevented. A concept of the guide shoe 6 in terms of a structure involves not only the guide shoe 6 itself but a joined state between the guide shoe 6 and the connector 10. The joined state corresponds to, for example, a fitting tolerance and application of an adhesive.

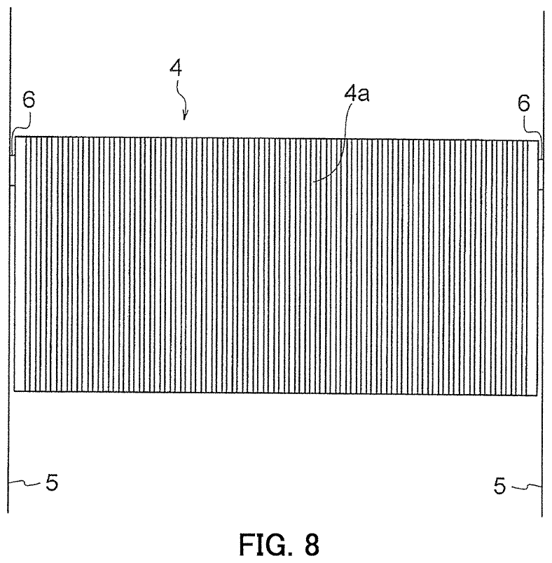

FIG. 8 is a view for illustrating a fitted state of the guide shoes 6 to be mounted to the step 4 into the connectors 10 and a positional relationship with respect to the skirt guards 5 when viewed from an upper surface side of the tread portion 4a of the step 4.

Referring to FIG. 8, when viewed from the upper surface side of the tread portion 4a of the step 4, distal end surfaces of both of the base portions 6a of the guide shoes 6 project beyond the end surfaces of the step 4. Thus, even when the step 4 is shifted to the right side or the left side of the traveling direction with respect to a moving direction due to, for example, stretching of the step chain 2 on one side, which is caused along with a continuous operation of the passenger conveyor 1, a surface of the base portion 6a of the guide shoe 6 first comes into sliding contact with the skirt guard 5. In this manner, the step 4 can be guided in the ascending direction or the descending direction without interference of a main body of the step 4 with the skirt guard 5.

Now, description is given of a phenomenon that abnormal noise is generated due to sliding between the guide shoe 6 and the skirt guard 5. As described above, when a dimension between the right and left skirt guards 5 is small at time of installation, an abnormality in the skirt guards 5 is liable to occur.

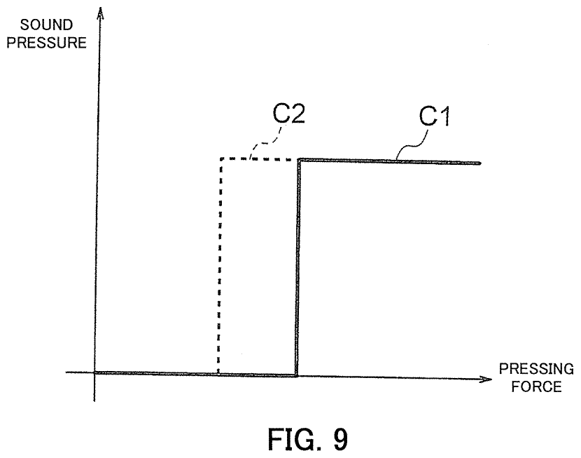

FIG. 9 is a characteristic graph for showing the sound pressure with respect to a pressing force between members relating to the dimension between the right and left skirt guards 5 of the passenger conveyor 1 and the generation of abnormal noise.

Referring to FIG. 9, a characteristic C1 indicated by a solid line represents a relationship of the sound pressure with respect to the pressing force between the members sliding against each other. A characteristic C2 indicated by a dotted line represents the above-mentioned relationship in a case in which a friction coefficient is increased. The characteristic C1 represents a state in which, when a magnitude of the pressing force becomes equal to or larger than a predetermined value, that is, the dimension between the right and left skirt guards 5 becomes equal to or smaller than a predetermined value, abnormal noise is suddenly generated. Further, the characteristic C2 represents a state in which, when the friction coefficient is increased, the abnormal noise is generated with a relatively small pressing force.

Thus, the abnormality detection device according to the first embodiment uses a relationship between the friction coefficient and liability of the generation of abnormal noise under an abnormality condition of the skirt guards 5. More specifically, the inspection guide shoes, each having a large friction coefficient, are mounted into the connectors 10 of the step 4 in advance at the time of maintenance or installation. The inspection guide shoes are slid so as to check presence or absence of the abnormal noise. In this manner, an abnormal portion of the skirt guards 5 is detected.

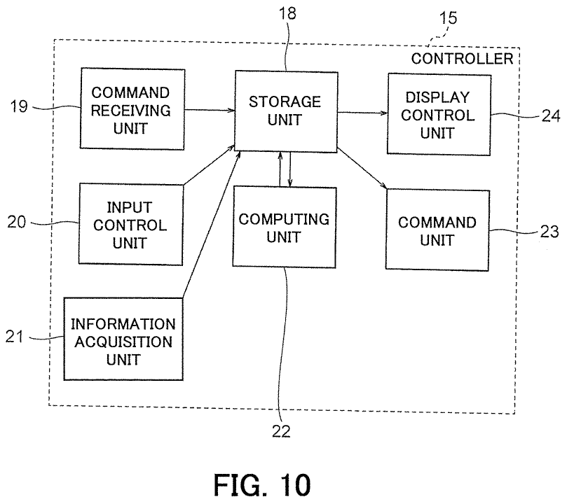

FIG. 10 is a functional block diagram for illustrating a detailed configuration of the controller 15 included in the abnormality detection device according to the first embodiment.

Referring to FIG. 10, the controller 15 includes a storage unit 18, a command receiving unit 19, an input control unit 20, an information acquisition unit 21, a computing unit 22, a command unit 23, and a display control unit 24.

In the controller 15, the storage unit 18 is configured to store not only built-in programs for executing functions of the above-mentioned units but also information specific to the passenger conveyor 1, which serves to determine an abnormality. The information specific to the passenger conveyor 1 includes a threshold value of a sound pressure level, a threshold value of a main frequency, a floor height, a step running velocity, and an operating direction. Further, the storage unit 18 also stores elapsed time from start of inspection and a value of the sound pressure or a value of the main frequency, which is received from the sound signal analysis unit 14.

The command receiving unit 19 is configured to receive a command generated by an input operation performed by a user through the input device 26. The command receiving unit 19 is configured to switch an operation mode of the abnormality detection device to a sound-pressure determination mode or a main-frequency determination mode, which are described later, in accordance with processing defined in the received command. Further, when the input operation is not performed through the input device 26 within a predetermined time period at the time of activation, the command receiving unit 19 can automatically switch the operation mode of the abnormality detection device to the sound-pressure determination mode.

The input control unit 20 is configured to input a start command for execution of the built-in program in accordance with the operation mode of the abnormality detection device among the built-in programs stored in the storage unit 18 and an operation start command for the passenger conveyor 1 by the input operation performed by the user through the input device 26. Further, the input control unit 20 can also input, for example, a start command for acquisition of information by the information acquisition unit 21 described later to the abnormality detection device.

The information acquisition unit 21 is configured to acquire the sound pressure level or the main frequency from the sound signal analysis unit 14. Further, when the sound signal acquisition unit 13 has a function of converting the sound pressure level or the main frequency and outputting a resultant to an outside, the information acquisition unit 21 can acquire the sound pressure level or the main frequency from the sound signal acquisition unit 13.

The computing unit 22 is configured to perform computation in accordance with the built-in program stored in the storage unit 18. As an example of the program, a position of an inspection guide shoe 7 in the passenger conveyor 1 is computed from elapsed time from the start of the operation of the passenger conveyor 1 and the running velocity of the step 4. At the same time, the computing unit 22 performs computation to determine whether or not abnormal noise is generated by comparing a magnitude of the value of the sound pressure level or the main frequency, which is acquired by the information acquisition unit 21, and a magnitude of the threshold value stored in the storage unit 18 with each other. Then, the computing unit 22 stores positional information of the skirt guards 5, at which the abnormal noise is generated, in the storage unit 18 as an output result.

The command unit 23 is configured to output an operation command for causing the steps 4 to run under conditions computed by the computing unit 22 to the passenger conveyor 1. The command unit 23 is connected to the control panel 25 provided in the machine room 1c of the passenger conveyor 1. Further, the command unit 23 can also be connected to the control panel 25 through the network 16.

The display control unit 24 is configured to control the display device 27 to display a result of the computation processing performed by the computing unit 22, that is, for example, an abnormality determination result.

The controller 15 can be formed of a computer. The computer is configured to store various kinds of built-in programs for executing various kinds of functions required for control of the units and various kinds of data required for information processing in a memory, and includes a processor configured to perform control processing in accordance with the programs and the data. Alternatively, the controller 15 may be formed of one or more digital circuits each being configured to execute processing of the various kinds of built-in programs, in which various kinds of data are preset.

In any cases, as illustrated in FIG. 1, the input device 26, the display device 27, the sound signal acquisition unit 13, the sound signal analysis unit 14, and the network 16 are connected to the controller 15. The input device 26 can input start of execution of the built-in program stored in the storage unit 18 to the device. Further, the input device 26 can also input start of acquisition of information by the information acquisition unit 21.

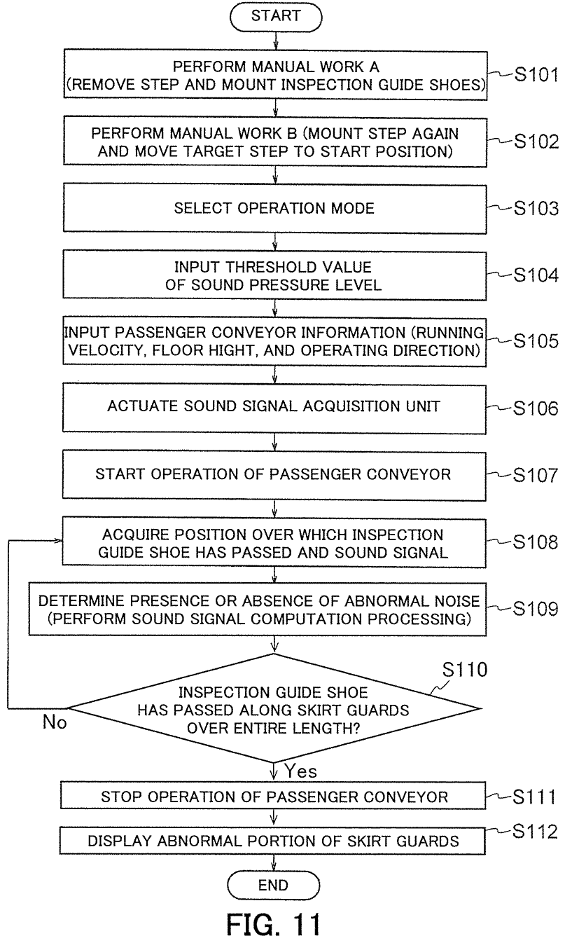

FIG. 11 is a flowchart for illustrating a procedure of abnormality detection processing in the sound-pressure determination mode, which is performed by the abnormality detection device according to the first embodiment.

Referring to FIG. 11, a manual work A to be performed in advance is first performed in Step S101 in the procedure of the abnormality detection processing in the sound-pressure determination mode. In the manual work A, the worker removes one of the steps 4 from the step shaft 3, and replaces the normal guide shoes 6 mounted into the connectors 10 of the step 4 with the inspection guide shoes. The normal guide shoes 6 are generally formed of a resin material having high slidability in view of a demanded function. Meanwhile, the inspection guide shoes are made of a material containing an elastomer having a larger friction coefficient than that of the resin material so as to more easily induce abnormal noise even at the time of installation or maintenance.

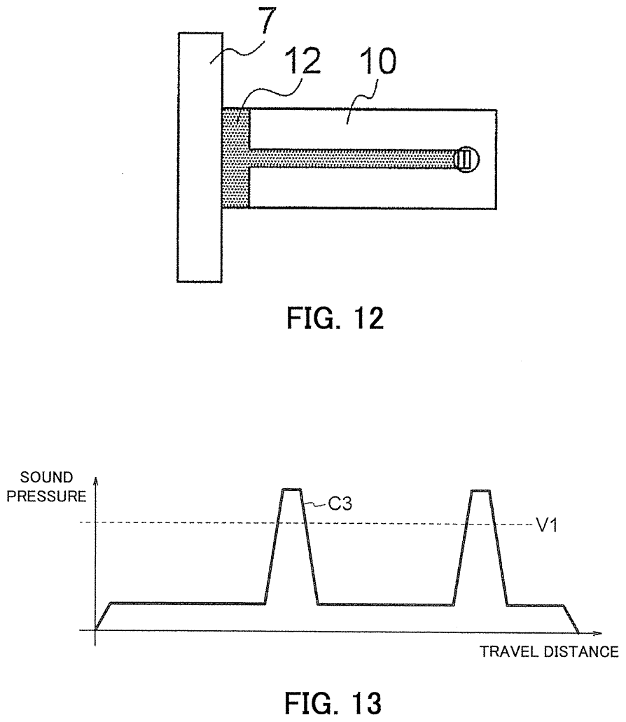

FIG. 12 is a partially transparent side view for exemplifying a fitted and bonded state of the inspection guide shoe 7, which is to be mounted to the step 4 to be used with the abnormality detection device according to the first embodiment, into the connector 10 when viewed along the plane orthogonal to the traveling direction of the step 4.

Now, referring to FIG. 12, in this case, when the inspection guide shoe 7 is fitted into the insertion hole 10a of the connector 10, a gap between the inspection guide shoe 7 and the connector 10 is filled with an adhesive 12. In this manner, when the connector 10 and the inspection guide shoe 7 are bonded with use of the adhesive 12 at the time of fitting therebetween, the inspection guide shoe 7 becomes more liable to induce the abnormal noise. The guide shoe 6 and the connector 10 are fitted and engaged with each other. Friction damping acts between the leg portions 6b and the claw portions 6c of the guide shoe 6, and the protruding portion 6d and an inner peripheral surface of the connector 10 due to contact therebetween.

Meanwhile, when the inspection guide shoe 7 and the connector 10 are bonded and fixed together with use of the adhesive 12 as indicated by a black area in FIG. 12 at the time of fitting therebetween, a friction damping effect is reduced, leading to a state in which the damping is reduced. As a result, the abnormal noise is more liable to be generated. For a fixing method using the adhesive 12, an epoxy resin-based adhesive, a silicon-based adhesive, or a quick setting adhesive is generally used. When the epoxy resin-based adhesive or the silicon-based adhesive is used, the inspection guide shoe 7 and the connector 10 are required to be held for a long period of time until the adhesive is cured.

Thus, in the first embodiment, the quick setting adhesive, that is, an instant adhesive is desirable. With the instant adhesive, working time is short, and a working method is simple and easy. When mechanical peel-off such as shear or scraping of a fixed material is difficult in removal of the inspection guide shoe 7 after the work, a dedicated solvent such as a stripping solution may be used or an external environment around the fixed material, such as a temperature or a humidity, may be manipulated.

Next, the processing proceeds to Step S102 in which a manual work B is performed. In the manual work B, the worker mounts the step 4 to the passenger conveyor 1 again. The passenger conveyor 1 is operated to move the step 4 being a target to which the inspection guide shoes 7 are mounted (hereinafter also referred to as “target step”) to a start position. For example, in a case of the passenger conveyor 1 for descending, the target step 4 is moved to the upper reverse position 1a at which guiding along the skirt guards 5 is started. Then, the passenger conveyor 1 is stopped, and a stop position is set as a position of start of the inspection. Further, in the case of the passenger conveyor 1 for ascending, the target step 4 is moved to the lower reverse position 1b at which the guiding along the skirt guards 5 is started. Then, the passenger conveyor 1 is stopped, and a stop position is set as the position of start of the inspection.

Further, the processing proceeds to Step S103 in which the operation mode is selected. In the selection of the operation mode, when, for example, the worker operates the input device 26 to select the sound-pressure determination mode, the operation mode of the abnormality detection device is switched to the sound-pressure determination mode by the command receiving unit 19. In this case, when the input operation is not performed by the worker through the input device 26 within a set time period at the time of activation, the command receiving unit 19 automatically switches the operation mode of the abnormality detection device to the sound-pressure determination mode. Subsequently, after the worker operates the input device 26 to instruct the start of execution, an execution instruction is input by the input control unit 20 to thereby start operation processing in the sound-pressure determination mode, which is performed by the abnormality detection device based on an application program.

Thus, the processing proceeds to Step S104. In Step S104, the threshold value of the sound pressure level is input by the operation of the input device 26, which is performed by the worker, as initial setting. At this time, the threshold value of the sound pressure level for checking the presence or absence of the abnormal noise is input through the input control unit 20. The threshold value may be input in advance from an outside through the input device 26.

After that, the processing proceeds to Step S105. In Step S105, the worker operates the input device 26 to input information of the passenger conveyor 1. The information of the passenger conveyor 1 includes the running velocity of the step 4, the floor height of the passenger conveyor 1, and the operating direction of the passenger conveyor 1. When the information of the passenger conveyor 1 is stored in advance in the storage unit 18 of the controller 15 or a database of a computer to be supervised on a control side, another operation becomes available. In this case, when the worker inputs an identification number assigned to the passenger conveyor 1 to be inspected to the input device 26, the information of the passenger conveyor 1 can be read from the database.

Subsequently, the processing proceeds to Step S106. In Step S106, the worker operates the input device 26 to actuate the input control unit 20 of the controller 15. Then, the sound signal acquisition unit 13 is switched to an actuated state in response to a command from the input control unit 20. After that, the processing proceeds to Step S107. In Step S107, the worker actuates the command unit 23 of the controller 15 to control the control panel 25 to thereby start the operation of the passenger conveyor 1. In this manner, the steps 4 start running.

Further, the processing proceeds to Step S108. In Step S108, the computing unit 22 of the controller 15 acquires the position of passage of the inspection guide shoe 7 and the sound signal. In this case, current positional information of the inspection guide shoe 7 on the skirt guards 5 is computed from elapsed time based on a running start time of the step 4 as a reference and the running velocity of the step 4, which has been input to the abnormality detection device in Step S105 by the computing unit 22. At the same time, the sound signal acquired by the sound signal acquisition unit 13 is analyzed by the sound signal analysis unit 14, and the sound pressure corresponding to an analysis result is transmitted to the controller 15.

After that, the processing proceeds to Step S109. In Step S109, the computing unit 22 of the controller 15 determines the presence or absence of the abnormal noise based on the sound pressure, which has been extracted from the sound signal by the sound signal analysis unit 14 and has been acquired through the information acquisition unit 21. The determination of the presence or absence of the abnormal noise may be regarded as an example of sound signal computation processing. Further, the processing proceeds to Step S110. In Step S110, the computing unit 22 of the controller 15 determines whether or not the inspection guide shoe 7 has passed along the skirt guards 5 over an entire length thereof based on the computed positional information of the inspection guide shoe 7. The passage along the skirt guards 5 over the entire length means, for example, passage through a forward path from the lower reverse position 1b to the upper reverse position 1a.

When it is determined that the inspection guide shoe 7 has passed along the skirt guards 5 over the entire length as a result of the determination, the processing proceeds to Step S111. In Step S111, the command unit 23 of the controller 15 commands the control panel 25 to stop the operation of the passenger conveyor 1. When it is determined that the inspection guide shoe 7 has not passed along the skirt guards 5 over the entire length, the processing returns to Step S108 to repeat the subsequent processing.

As a last step, the processing proceeds to Step S112. In Step S112, the computing unit 22 of the controller 15 commands the display control unit 24 to display an abnormal portion of the skirt guards 5 as an abnormality detection result on a display portion of the display device 27.

FIG. 13 is a graph for showing a characteristic C3 of the sound pressure with respect to a travel distance of the inspection guide shoe 7, which is associated with the abnormality detection result in the sound-pressure determination mode, which is obtained by the abnormality detection device according to the first embodiment.

Referring to FIG. 13, as represented by the characteristic C3, a region in which the sound pressure increases to exceed a set threshold value V1 along with an increase in travel distance of the inspection guide shoe 7 is determined as a portion of the skirt guards 5, in which an abnormality occurs. Thus, the portion of the skirt guards 5, which corresponds to the region described above, is output to the display device 27.

In this case, as the abnormal portion, for example, a distance from a start point of the inspection guide shoe 7 may be displayed. Further, in the passenger conveyor 1, the forward path is formed by arranging the plurality of skirt guards 5 along the traveling direction of the steps 4. Thus, the skirt guard 5 may be identified with an order when being counted from an upper side or a lower side in the arrangement of the skirt guards 5 in the passenger conveyor 1. In a case of the moving walkway, the skirt guard 5 is identified with an order when being counted from a front side or a rear side. The worker checks the display portion of the display device 27 to recognize the detected abnormal portion of the skirt guards 5. Then, the abnormality detection processing is terminated.

As described above, with the abnormality detection device of the first embodiment, the abnormality detection is performed with the precondition that the worker replaces some of the normal guide shoes 6 of the steps 4 with the inspection guide shoes 7. Then, the worker moves the step 4, to which the inspection guide shoes 7 are mounted after the replacement, to the upper reverse position 1a or the lower reverse position 1b of the passenger conveyor 1. Further, the worker operates the passenger conveyor 1 to cause the step 4, to which the inspection guide shoes 7 are mounted after the replacement, to run. Then, the sound signal and the position of passage of the inspection guide shoe 7 are simultaneously acquired by the controller 15. The controller 15 displays the result of determination of the presence or absence of the abnormal noise at each position on the display portion of the display device 27.

Specifically, with the abnormality detection device of the first embodiment, some of the guide shoes 6 are replaced with the inspection guide shoes 7 so as to perform the abnormality detection processing. Thus, before the guide shoe 6 slides against the skirt guard 5 to generate the abnormal noise, an abnormal portion of the skirt guards 5 can be continuously detected. Specifically, the passenger conveyor 1 is operated, and the abnormality in the skirt guards 5 can be continuously detected with use of the inspection guide shoes 7 before the abnormal noise is generated with the normal guide shoes 6. When only checking the abnormality detection result displayed on the display portion, the worker can easily recognize the abnormal portion of the skirt guards 5. Thus, the worker is only required to focus on the skirt guard 5 having the abnormal portion and perform installation adjustment work for the skirt guard 5 with use of, for example, normally used measurement apparatus and tool.

### Second Embodiment

In the abnormality detection device of the first embodiment, the characteristic of the sliding phenomenon is used. Specifically, at the time of sliding of the inspection guide shoe 7 along the skirt guards 5, the abnormal noise is suddenly generated when the pressing force exceeds the pressing force equal to or larger than the predetermined value. Then, the region in which the acquired sound pressure exceeds the set threshold value V1 is detected as the abnormal portion of the skirt guards 5. In an abnormality detection device of a second embodiment, a pressing force, which is supposed not from the sound pressure of the abnormal noise but from the main frequency of the abnormal noise, is computed by the computing unit 22 of the controller 15 so as to detect the abnormal portion of the skirt guards 5. In this case, an abnormality that a dimension between the right and left skirt guards 5 is reduced is detected as a target to be detected among abnormalities of the skirt guards 5.

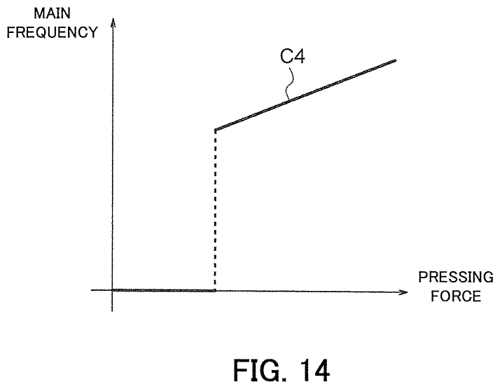

FIG. 14 is a graph for showing a characteristic C4 of the main frequency with respect to the pressing force between the members, which is computed by the computing unit 22 of the controller 15 included in the abnormality detection device according to the second embodiment.

Referring to FIG. 14, the characteristic C4 represents a state in which, when the pressing force increases, the main frequency indicating a frequency at which the abnormal noise is generated is excited. The abnormal sound is generated due to vibration of the inspection guide shoe 7, which is caused by excitation of a frequency close to a natural frequency of the inspection guide shoe 7.

In particular, in a case in which the inspection guide shoe 7 is made of a resin exhibiting high non-linearity, as the pressing force increases under a state in which the inspection guide shoe 7 and the skirt guard 5 are in contact with each other, contact stiffness also increases. As a result, the natural frequency of the inspection guide shoe 7 itself increases, and the main frequency of the abnormal noise also increases. The abnormality detection device of the second embodiment uses the characteristic C4 described above to detect an abnormal portion of the skirt guards 5, which is included in a portion over which the inspection guide shoe 7 passes, from a value of the main frequency of the abnormal noise.

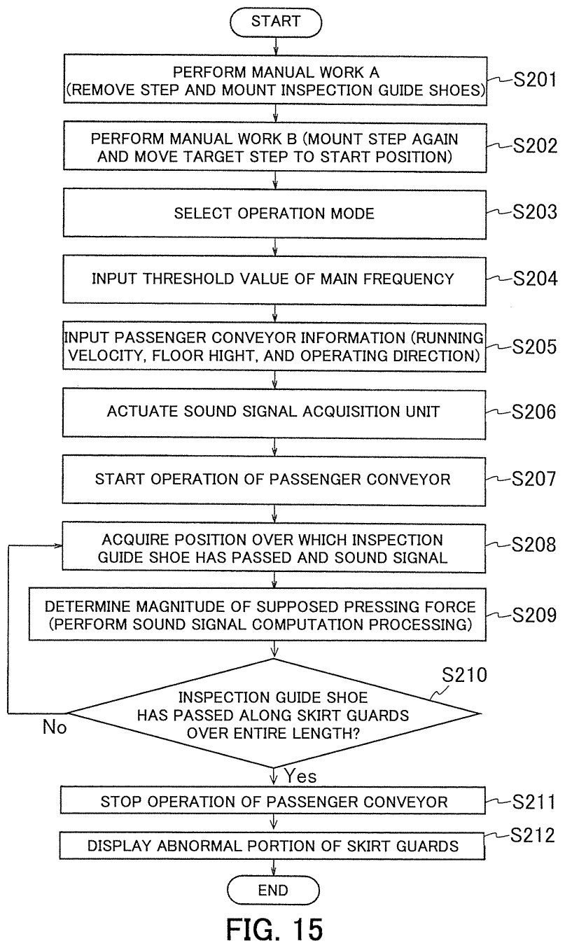

FIG. 15 is a flowchart for illustrating a procedure of abnormality detection processing in the main-frequency determination mode, which is performed by the abnormality detection device according to the second embodiment.

Referring to FIG. 15, the manual work A to be performed in advance is performed in Step S201 in the procedure of the abnormality detection processing in the main-frequency determination mode. The manual work A is the same as that performed in Step S101 illustrated in FIG. 11 in the first embodiment. Further, the manual work B in subsequent Step S202 is also the same as that performed in Step S102 illustrated in FIG. 11.

Further, the processing proceeds to Step S203. In Step S203, the operation mode is selected. In the selection of the operation mode, when, for example, the worker operates the input device 26 to select the main-frequency determination mode, the operation mode of the abnormality detection device is switched to the main-frequency determination mode by the command receiving unit 19.

Thus, the processing proceeds to Step S204. In Step S204, the threshold value of the main frequency is input through the operation of the input device 26, which is performed by the worker, as initial setting. In this step, the threshold value of the main frequency for checking the presence or absence of the abnormal noise is input through the input control unit 20. The threshold value may be input in advance by the input device 26 from the outside. The threshold value of the main frequency may be input in the following manner A relationship between the pressing force and the natural frequency is acquired in advance through an experiment such as an excitation test. The threshold value of the main frequency is input based on the obtained value as a reference.

Subsequent Step S205 to Step S208 are the same as Step S105 to Step S108 illustrated in FIG. 11 according to the first embodiment, and description thereof is omitted.

After that, the processing proceeds to Step S209. In Step S209, the computing unit 22 of the controller 15 determines a magnitude of a supposed pressing force based on the main frequency, which has been extracted from the sound signal by the sound signal analysis unit 14 and has been acquired through the information acquisition unit 21. The determination of the magnitude of the supposed pressing force may be regarded as another example of the sound signal computation processing. Further, the processing proceeds to Step S210. In Step S210, the computing unit 22 of the controller 15 determines whether or not the inspection guide shoe 7 has passed along the skirt guards 5 over the entire length based on the computed positional information of the inspection guide shoe 7. Also in this case, the passage along the skirt guards 5 over the entire length means, for example, the passage through the forward path from the lower reverse position 1b to the upper reverse position 1a.

When it is determined that the inspection guide shoe 7 has passed along the skirt guards 5 over the entire length as a result of the determination, the processing proceeds to Step S211. In Step S211, the command unit 23 of the controller 15 commands the control panel 25 to stop the operation of the passenger conveyor 1. When it is determined that the inspection guide shoe 7 has not passed along the skirt guards 5 over the entire length, the processing returns to Step S208 to repeat the subsequent processing.

As a final step, the processing proceeds to Step S212. In Step S212, the computing unit 22 of the controller 15 commands the display control unit 24 to display an abnormal portion of the skirt guards 5 on the display portion of the display device 27 as an abnormality detection result.

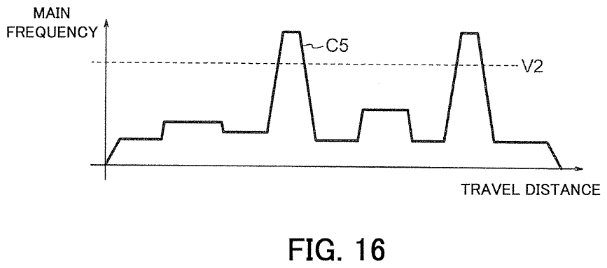

FIG. 16 is a graph for showing a characteristic C5 of the main frequency with respect to the travel distance of the inspection guide shoe 7, which is associated with the abnormality detection result in the main-frequency determination mode, which is obtained by the abnormality detection device according to the second embodiment.

Referring to FIG. 16, as represented by the characteristic C5, a region in which the main frequency increases to exceed a set threshold value V2 along with an increase in travel distance of the inspection guide shoe 7 is determined as a portion of the skirt guards 5, in which the abnormality occurs. Thus, the portion of the skirt guards 5, which corresponds to the region described above, is output to the display device 27. The worker checks the display portion of the display device 27 to recognize the detected abnormal portion of the skirt guards 5. Then, the abnormality detection processing is terminated.

As described above, with the abnormality detection device of the second embodiment, the abnormality detection is performed with the precondition that the worker replaces some of the normal guide shoes 6 of the steps 4 with the inspection guide shoes 7. Then, the worker moves the step 4, to which the inspection guide shoes 7 are mounted after the replacement, to the upper reverse position 1a or the lower reverse position 1b of the passenger conveyor 1. Further, the worker operates the passenger conveyor 1 to cause the step 4, to which the inspection guide shoes 7 are mounted after the replacement, to run. Then, the sound signal and the position of passage of the inspection guide shoe 7 are simultaneously acquired by the controller 15. The controller 15 displays the result of determination of the magnitude of the supposed pressing force at each position on the display portion of the display device 27.

Specifically, also in a case of the abnormality detection device of the second embodiment, the passenger conveyor 1 is operated, and an abnormality in the skirt guards 5 can be continuously detected with use of the inspection guide shoes 7 before the abnormal noise is generated with the normal guide shoes 6. When only checking the abnormality detection result displayed on the display portion, the worker can easily recognize the abnormal portion of the skirt guards 5. Thus, the worker is only required to focus on the skirt guard 5 having the abnormal portion and perform the installation adjustment work for the skirt guard 5.

### Third Embodiment

In the above-mentioned abnormality detection devices of the first embodiment and the second embodiment, the abnormal portion of the skirt guards 5 has been detected as a target of detection in terms of the generation of abnormal noise. In the passenger conveyor 1, however, it is stipulated in regulations that the gap width between the tread portion 4a of the step 4 and each of the right and left sides of the skirt guard 5 is set to be equal to or smaller than a given value. Thus, a portion in which the dimension between the right and left skirt guards 5 is equal to or larger than a prescribed value is also required to be checked.

Thus, an abnormality detection device of a third embodiment has a configuration in which at least one of the abnormality detection devices described in the embodiments and the skirt guard gap measurement device described in Patent Literature 1, which is configured to record the gap width between the skirt guard 5 and the step 4, are combined. Alternatively, in place of the skirt guard gap measurement device described in Patent Literature 1, a technology relating to a skirt guard gap adjustment method disclosed in Japanese Patent No. 4728768 may be applied. As a configuration obtained by the combination thereof, the installation of the skirt guards 5 is inspected.

Specifically, in the configuration of the third embodiment, a trajectory of the guide shoe 6 or the inspection guide shoe 7 and a trajectory of the tread portion 4a of the step 4 are different from each other. With a combination of the devices, however, the above-mentioned trajectories can be simultaneously inspected. In the simultaneous inspection, both of the abnormal portion of the skirt guards 5, which is included in a portion over which the inspection guide shoe 7 has passed, and the gap width dimension between the tread portion 4a of the step 4 and the skirt guard 5, which is stipulated in regulations, are targets to be detected through one operation of the passenger conveyor 1.

Also in the configuration of the third embodiment, the manual work A and the manual work B as those described in the first embodiment or the second embodiment are performed in the same manner. The abnormal noise may easily be induced by using a material containing an elastomer having a larger friction coefficient than that of a resin material for the inspection guide shoe 7 or performing bonding and fixing with use of the adhesive 12 for fitting into the connector 10. The target step 4, to which the inspection guide shoes 7 are mounted, is moved to the vicinity of the upper reverse position 1a or the lower reverse position 1b. Then, the device described in Patent Literature 1 or a device of the technology relating to Japanese Patent No. 4728768 is fixed to the tread portion 4a of the target step 4 or the step 4 in the vicinity thereof.

After that, the abnormal noise generated due to the sliding of the inspection guide shoes 7, which is caused by the operation of the passenger conveyor 1, and the measurement of the gap width between the tread portion 4a of the step 4 and the skirt guards 5 are simultaneously performed in accordance with the procedure of the abnormality detection processing described in the first embodiment or the second embodiment. The worker recognizes the detected abnormal portion of the skirt guards 5 by checking outputs thereof. Then, the abnormality detection processing is terminated.

The abnormality detection device according to the present invention is not limited to those of the embodiments described above, and encompasses all possible combinations of features thereof. In particular, the inspection guide shoe 7 may be achieved in various modes. For example, the inspection guide shoe 7 may be made of an elastomer material having a larger friction coefficient than that of a sliding resin material, may be made of a material having a larger friction coefficient than that of the guide shoe 6, or may be bonded and fixed to the step. Further, the inspection guide shoe 7 may be more firmly fixed or bonded to the step 4 than the guide shoe 6. Further, the inspection guide shoe 7 may be more firmly supported to the step 4 than the guide shoe 6.

In any cases, in the modes described above, when disturbance to the passenger conveyor 1 such as a deposit on a sliding surface or vibration of another mechanical component occurs, the inspection guide shoe 7 can be placed in a state of easily generating the abnormal noise. As a result, before the abnormal noise is generated with the normal guide shoes 6, the abnormal portion of the skirt guards 5 can be accurately detected with use of the inspection guide shoes 7.

### REFERENCE SIGNS LIST

1 passenger conveyor, la upper reverse position, 1b lower reverse position, 1c machine room, 2 step chain, 3 step shaft, 4 step, 5 skirt guard, 6 guide shoe, 6a base portion, 6b leg portion, 6c claw portion, 6d protruding portion, 7 inspection guide shoe, 9 bracket, 10 connector, 10a insertion hole, 10b drilled hole, 10c groove, 11 engagement portion, 12 adhesive, 13 sound signal acquisition unit, 14 sound signal analysis unit, 15 controller, 16 network, 17 external device, 18 storage unit, 19 command receiving unit, 20 input control unit, 21 information acquisition unit, 22 computing unit, 23 command unit, 24 display control unit, 25 control panel, 26 input device, 27 display device

1. A passenger conveyor abnormality detection device configured to detect an abnormality in skirt guards, which are provided upright, at time of inspection work for a passenger conveyor having a structure in which guide shoes mounted to each of steps slide along the skirt guards to guide the steps, the passenger conveyor abnormality detection device comprising:
inspection guide shoes to be mounted to one of the steps;
a sound signal acquisition processor configured to convert a sound wave around each of the inspection guide shoes into a sound signal;
a command generator configured to command an operation for causing the steps to run;
a sound signal analyse configured to analyze the sound signal acquired by the sound signal acquisition processor under a state in which the steps are caused to run by the command generator and extract a sound pressure or a main frequency; and
an abnormality determination processor configured to specify an abnormal portion of the skirt guards based on the sound pressure or the main frequency, which has been extracted by the sound signal analyse.

2. The passenger conveyor abnormality detection device according to claim 1, wherein the inspection guide shoes are made of an elastomer material having a larger friction coefficient than a friction coefficient of a sliding resin material.

3. The passenger conveyor abnormality detection device according to claim 1, wherein the inspection guide shoes are made of a material having a larger friction coefficient than a friction coefficient of the guide shoes.

4. The passenger conveyor abnormality detection device according to claim 1, wherein the inspection guide shoes are bonded and fixed to the one step.

5. The passenger conveyor abnormality detection device according to claim 1, wherein the inspection guide shoes are more firmly fixed or bonded to the one step than the guide shoes.

6. The passenger conveyor abnormality detection device according to claim 1, wherein the inspection guide shoes are more firmly supported to the one step than the guide shoes.

7. The passenger conveyor abnormality detection device according to claim 2, wherein the inspection guide shoes are bonded and fixed to the one step.

8. The passenger conveyor abnormality detection device according to claim 2, wherein the inspection guide shoes are more firmly fixed or bonded to the one step than the guide shoes.

9. The passenger conveyor abnormality detection device according to claim 2, wherein the inspection guide shoes are more firmly supported to the one step than the guide shoes.

10. The passenger conveyor abnormality detection device according to claim 3, wherein the inspection guide shoes are bonded and fixed to the one step.

11. The passenger conveyor abnormality detection device according to claim 3, wherein the inspection guide shoes are more firmly fixed or bonded to the one step than the guide shoes.

12. The passenger conveyor abnormality detection device according to claim 3, wherein the inspection guide shoes are more firmly supported to the one step than the guide shoes.
